(19) United States
(12) Patent Application Publication
(10) Pub. No.: US 2014/0365262 A1
(43) Pub. Date: Dec. 11, 2014

(54) ELECTRONIC DEVICE AND AGENDA REMINDING METHOD

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: FA-HUA OUYANG, Shenzhen (CN); XIN LU, Shenzhen (CN); YU-CUI ZHOU, Shenzhen (CN)

(21) Appl. No.: 14/295,498

(22) Filed: Jun. 4, 2014

(30) Foreign Application Priority Data
Jun. 6, 2013 (CN) 2013102218196

(51) Int. Cl. G06Q 10/10; H04W 4/02

(52) U.S. Cl. CPC G06Q 10/1095; H04W 4/027
USPC 705/7.19

(57) ABSTRACT

In an agenda notification method of an electronic device, an applicable reminding time period and an alarm time is set for each of one or more agendas created in the electronic device. A movement state of the electronic device is detected in real-time to determine whether the movement state of electronic device changes from a static state to a moving state. When the movement state of the electronic device changes from the static state to the moving state and a current time is within the applicable reminding time period of an agenda, a notification is output to remind a user.

This application claims all benefits accruing under 35 U.S.C. §119 from Chinese Patent Application No. 201310221819.6, filed on Jun. 6, 2013 in Chinese Intellectual Property Office, the content of which is hereby incorporated by reference.

### FIELD

Embodiments of the present disclosure relate generally to agenda management of electronic devices, and particularly to an agenda reminding method of an electronic device.

### BACKGROUND

Many electronic devices, such as smart phones, laptop computers, and personal digital assistants (PDAs), provide agenda functions for users to establish agendas. The agendas may remind users to attend a meeting, and visit friends, for example. In some particular situations, for example, when a user sets an agenda as a reminder to bring an object before a meeting, if the user leaves before the reminder the agenda may become no use.

### BRIEF DESCRIPTION OF THE DRAWINGS

FIG. 1 is a schematic block diagram illustrating one embodiment of an electronic device.

FIG. 2 is a schematic diagram of a notification interface of an agenda when the electronic device changes to a moving state from a static state.

FIG. 3 is a schematic diagram of the electronic device notifying a user at a predetermined reminding time of the agenda.

FIG. 4 is a flowchart of one embodiment of an agenda notification method implemented by the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

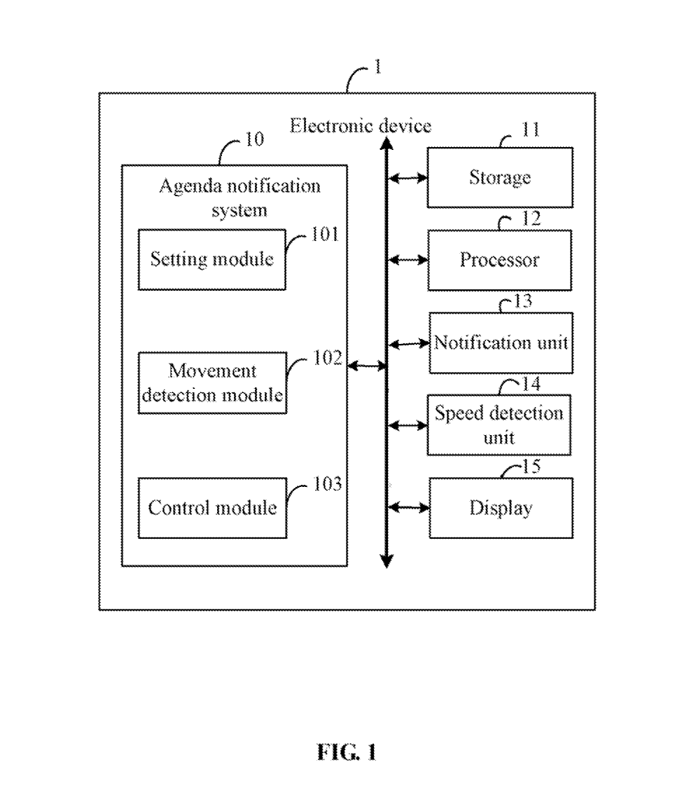

FIG. 1 is a schematic block diagram illustrating one embodiment of an electronic device 1. The electronic device 1 includes an agenda notification system 10, a storage 11, a processor 12, a notification unit 13, a speed detection unit 14, and a display 15. In the embodiment, the electronic device 1 can be a smart phone, a mobile Internet device (MID), a tablet computer, for example. FIG. 1 illustrates one embodiment of the electronic device 1, and it can include more or fewer components than those shown in the embodiment, or have a different configuration of the components.

The agenda notification system 10 can include a plurality of programs in the form of one or more computerized instructions stored in the storage 11 and executed by the processor 12 to perform operations of the electronic device 1. In the embodiment, the agenda notification system 10 includes a setting module 101, a movement detection module 102, and a control module 103. The storage 11 can be an external or embedded storage medium of the electronic device 1, such as a secure digital memory (SD) card, a Trans Flash (TF) card, a compact flash (CF) card, or a smart media (SM) card.

In general, the word “module,” as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage devices. Some non-limiting examples of non-transitory computer-readable medium include CDs, DVDs, BLU-RAY, flash memory, and hard disk drives.

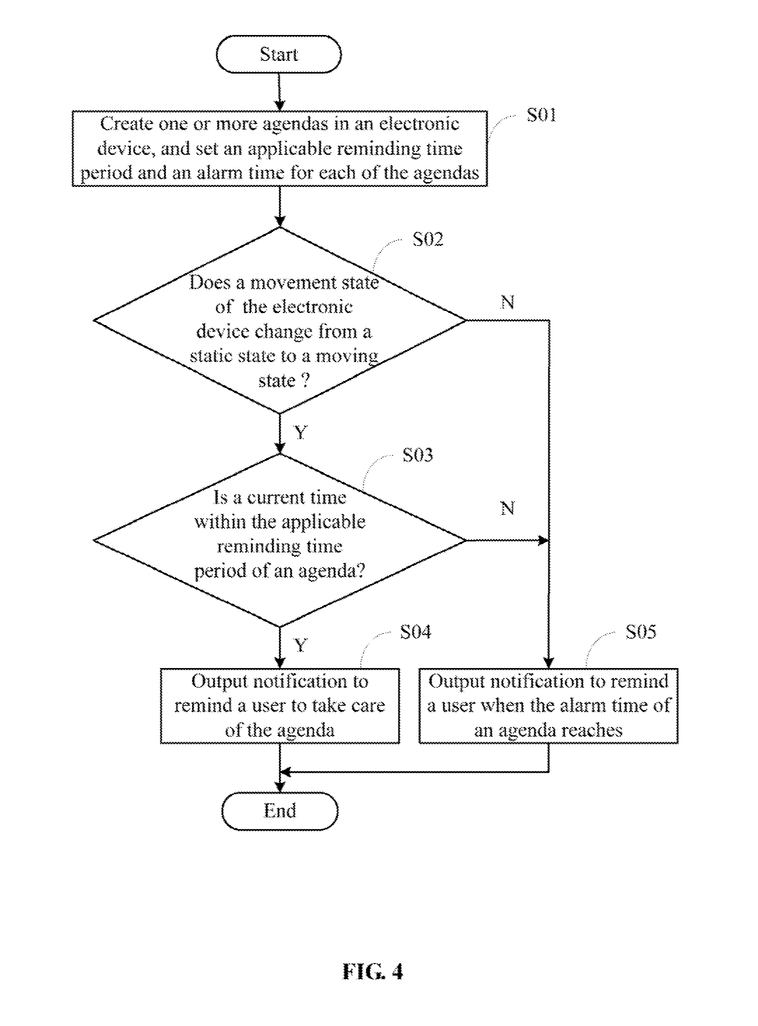

FIG. 4 illustrates a flowchart of one embodiment of an agenda notification method using the functional modules of the agenda notification system 10 of FIG. 1. Depending on the embodiment, additional steps may be added, others removed, and the ordering of the steps may be changed.

In S01, the setting module 101 creates one or more agendas in the electronic device 1, and sets an applicable reminding time period and an alarm time for each of the agendas. For example, the setting module 101 may set a time period of 9 a.m. to 10 a.m. as the applicable reminding time period of an agenda, and set 9.50 a.m. as the alarm time of the agenda.

In this embodiment, an application such as “Alarm Clock” or “Calendar” can be installed in the electronic device 1. The one or more agendas can be set using the setting module 101 when the application is activated. In addition, a notification manner can be set using the setting module 101 for each of the one or more agendas. For example, the notification manner can be text box, ringtones, or vibration. Content to be displayed in the text box can be manually preset and stored in the storage 11. For example, the content to be displayed in the text box can be “Remember to bring a book”.

In S02, the movement detection module 102 detects a movement state of the electronic device 1 in real-time and determines whether the movement state of electronic device 1 changes from a static state to a moving state. If the movement state of the electronic device 1 changes from the static state to the moving state, S03 is implemented, otherwise, S05 is implemented.

In at least one embodiment, the movement detection module 102 can detect the movement state of the electronic device 1 at regular intervals. For example, the movement detection module 102 can activate the speed detection unit 14 to detect a speed of the electronic device 1, and detect the movement state of the electronic device 1 according to the speed of the electronic device 1. The speed detection unit 14 can be a global positioning system (GPS) of the electronic device 1. In one embodiment, the movement state of the electronic device 1 is determined to be the static state if the speed of the electronic device 1 is zero or is less than a predetermined speed within a predetermined time interval (e.g., 30 seconds). Accordingly, the movement state of the electronic device 1 is determined to be the moving state if the speed of the electronic device 1 is not zero or is greater than the predetermined speed within the predetermined time interval (e.g., 30 seconds).

In step S03, the control module 103 determines whether a current time is within the applicable reminding time period of an agenda. If the current is within the applicable reminding time period of the agenda, S04 is implemented. Otherwise, S05 is implemented.

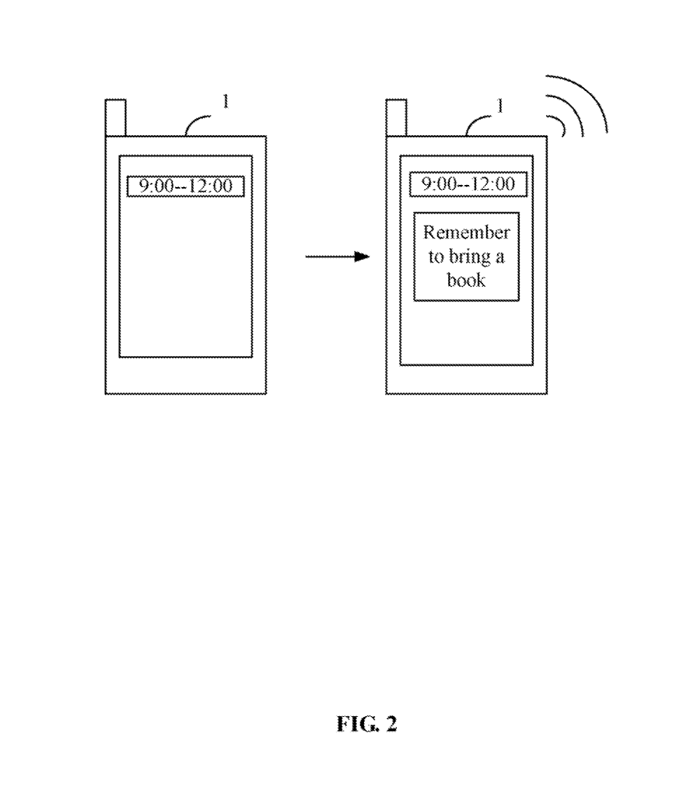

In S04, the control module 103 controls electronic device 1 to output notification to remind the user to pay attention to the agenda, the procedure ends. For example, FIG. 2 is a schematic diagram of a notification interface of an agenda when the electronic device 1 changes to a moving state from a static state, the electronic device 1 can display a text message (e.g., Please remember to bring a book) via the display 15 to remind the user. In at least one embodiment, the electronic device 1 can further generate a ringtone or vibration using notification unit 13 to notify the user when the text message is displayed. The notification unit 13 can be a speaker or a vibrator.

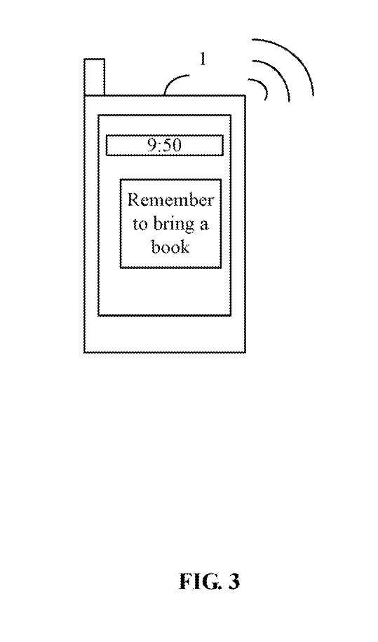

In S05, the control module 103 controls the electronic device 1 to output the notification to remind the user when the alarm time of the agenda reaches. For example, FIG. 3 is a schematic diagram of the electronic device 1 notifying a user at a predetermined reminding time of the agenda, when the alarm time (e.g., 9.40 a.m.) reaches, the electronic device 1 can display the text message of “Please remember to bring a book” via the display 15 to remind the user.

Although certain embodiments of the present disclosure have been specifically described, the present disclosure is not to be construed as being limited thereto. Various changes or modifications may be made to the present disclosure without departing from the scope of the present disclosure or the following claims.

What is claimed is:

1. An agenda notification method implemented by an electronic device, the method comprising:
creating one or more agendas in the electronic device;
setting an applicable reminding time period and an alarm time for each of the agendas;
detecting a movement state of the electronic device in real-time and determining whether the movement state of electronic device changes from a static state to a moving state;
determining whether a current time is within the applicable reminding time period of an agenda when the movement state of the electronic device changes from the static state to the moving state; and
outputting at least one notification to the electronic device containing an indication regarding to the agenda when the current time is within the applicable reminding time period of the agenda.

2. The method according to claim 1, wherein the movement state of the electronic device is detected at regular intervals.

3. The method according to claim 1, wherein the electronic device comprises a speed detection unit to detect a speed of the electronic device, and the movement state of the electronic device is detected according to the speed of the electronic device.

4. The method according to claim 3, wherein the movement state of the electronic device is determined to be the static state if the speed of the electronic device is zero or is less than a predetermined speed within a predetermined time interval.

5. The method according to claim 4, wherein the movement state of the electronic device is determined to be the moving state if the speed of the electronic device is not zero or is greater than the predetermined speed within the predetermined time interval.

6. The method according to claim 1, further comprising:
outputting the at least one notification when the alarm time of the agenda reaches upon the condition that the movement state of the electronic device does not change from the static state to the moving state.

7. The method according to claim 6, wherein the notification is a text box comprising a text message displayed on a display of the electronic device.

8. The method according to claim 6, wherein the notification further comprise a ringtone and vibration generated by a notification unit of the electronic device.

9. An electronic device, comprising:
a storage;
a processor; and
one or more programs stored in the storage and executed by the processor to perform an agenda notification method, the method comprising:
creating one or more agendas in the electronic device;
setting an applicable reminding time period and an alarm time for each of the agendas;
detecting a movement state of the electronic device in real-time and determining whether the movement state of electronic device changes from a static state to a moving state;
determining whether a current time is within the applicable reminding time period of an agenda when the movement state of the electronic device changes from the static state to the moving state; and
outputting at least one notification to the electronic device containing an indication regarding to the agenda when the current time is within the applicable reminding time period of the agenda.

10. The electronic device according to claim 9, wherein the movement state of the electronic device is detected at regular intervals.

11. The electronic device according to claim 9, wherein the electronic device comprises a speed detection unit to detect a speed of the electronic device, and the movement state of the electronic device is detected according to the speed of the electronic device.

12. The electronic device according to claim 11, wherein the movement state of the electronic device is determined to be the static state if the speed of the electronic device is zero or is less than a predetermined speed within a predetermined time interval.

13. The electronic device according to claim 12, wherein the movement state of the electronic device is determined to be the moving state if the speed of the electronic device is not zero or is greater than the predetermined speed within the predetermined time interval.

14. The electronic device according to claim 1, wherein the method further comprises:
outputting the at least one notification when the alarm time of the agenda reaches upon the condition that the movement state of the electronic device does not change from the static state to the moving state.

15. The electronic device according to claim 14, wherein the notification is a text box comprising a text message displayed on a display of the electronic device.

16. The electronic device according to claim 15, wherein the notification further comprise a ringtone and vibration generated by a notification unit of the electronic device.
